(19) United States
(12) Patent Application Publication
(10) Pub. No.: US 2025/0344680 A1
(43) Pub. Date: Nov. 13, 2025

(54) RECIRCULATING AQUACULTURE SYSTEM AND METHOD

(71) Applicant: Superior Fresh LLC, Hixton, WI (US)

(72) Inventor: Steven T. Summerfelt, Sharpsburg, MD (US)

(21) Appl. No.: 19/275,476

(22) Filed: Jul. 21, 2025

Related U.S. Application Data
(62) Division of application No. 17/891,782, filed on Aug. 19, 2022.

(51) Int. Cl. A01K 63/04; A01K 61/10; C02F 1/64; C02F 1/66; C02F 1/74; C02F 1/78; C02F 101/20; C02F 103/20

(52) U.S. Cl. CPC A01K 63/047; A01K 61/10; A01K 63/042; A01K 63/045; C02F 1/64; C02F 1/66; C02F 1/74; C02F 1/78; C02F 2101/203; C02F 2103/20; C02F 2209/06; C02F 2209/10; C02F 2209/24; C02F 2301/046

(57) ABSTRACT

A recirculating aquaculture system for producing aquatic species suitable for human consumption includes: a culture tank providing habitat for a selected aquatic species; a plurality of subsystems in communication with the culture tank and configured to recirculate and treat water within the system, the plurality of subsystems comprising: a solids control subsystem for removing particulates in the water, a recirculating pump subsystem for recirculating water within the system, an aeration/stripping subsystem for contacting air and water to strip carbon dioxide out of the water and into the air, a pH control subsystem to maintain the alkalinity of the water, an oxygenation subsystem for providing oxygen to the water, and an optional ozonation subsystem for providing ozone to the water; and wherein the water comprises iron cations at a concentration of at least about 0.1 ppm. Methods of maintaining the recirculating aquaculture system are also described.

### CROSS REFERENCE TO RELATED APPLICATIONS

This application is a divisional of copending U.S. patent application Ser. No. 17/891,782 filed Aug. 19, 2022 to Summerfelt, entitled “Recirculating Aquaculture System and Method”, incorporated herein by reference.

### FIELD OF THE INVENTION

This disclosure relates to animal husbandry, and more particularly, to equipment and methods for farming or producing fish for human consumption.

### BACKGROUND

Recirculating aquaculture systems (RAS) include a series of treatment processes or subsystems utilized to maintain water quality in intensive fish farming operations. Instead of the traditional method of growing fish outdoors, RAS rears fish at high densities typically in indoor tanks under a controlled environment. RAS filters and cleans the water for recycling through fish culture tanks. Water is typically recirculated when there is a specific need to minimize water replacement, to maintain water quality conditions which differ from the supply water, or to compensate for an insufficient water supply or a stringent wastewater discharge limit. There are many designs for recirculating systems. RAS typically include aeration or reoxygenation of culture water as it returns to the fish tank, removal of particulate matter such as fish feces and uneaten fish feed particles, biological filtration to remove dissolved wastes (primarily ammonia and organic matter), and maintenance of pH.

RAS are used to produce millions of Atlantic salmon smolt in North America and most other major salmon producing countries. Today, commercial RAS facilities are used to produce market-size Atlantic salmon, tilapia, barramundi, sea bass, and other species across the globe, but particularly in Canada, Europe, China, and the United States.

### SUMMARY OF THE INVENTION

A recirculating aquaculture system for producing aquatic species suitable for human consumption is described and includes: a culture tank providing habitat for a selected aquatic species; a plurality of subsystems in communication with the culture tank and configured to recirculate and treat water within the system, the plurality of subsystems comprising: a solids control subsystem for removing particulates in the water, a recirculating pump subsystem for recirculating water within the system, an aeration/stripping subsystem for contacting air and water to strip carbon dioxide out of the water and into the air, a pH control subsystem to maintain the alkalinity/pH of the water, an oxygenation subsystem for providing oxygen to the water, and an optional ozonation subsystem for providing ozone to the water; and wherein the water comprises iron cations at a concentration of at least about 0.1 ppm. In some embodiments, the concentration of iron cations may be at least about 2 ppm, from about 0.1 ppm to about 100 ppm, or from about 0.1 ppm to about 20 ppm. In some embodiments, the chelating agent may be maintained at a concentration from about 0.1 to about 20 ppm or from about 2 ppm to about 10 ppm.

The recirculating aquaculture system and methods described herein can utilize freshwater, brackish water or seawater. Many types of aquatic species, such as salmon, are suitable for use with the system and methods described herein.

The recirculating aquaculture system and methods described herein are suitable for use with a variety of different types of systems. For example, the recirculating aquaculture system generally includes recirculating pump subsystem which may replace, by volume, less than about 500%, less than about 200%, less than about 10%, or less than about 1%, of the recirculating water on a daily basis with cleaned and disinfected groundwater or surface water.

In some embodiments, the recirculating aquaculture system further comprises a hydroponic system in communication with the plurality of subsystems.

Methods of maintaining the recirculating aquaculture system for producing aquatic species suitable for human consumption include: providing a culture tank providing habitat for a selected aquatic species and a plurality of subsystems in communication with the culture tank and configured to recirculate and treat water within the system, and maintaining a concentration of iron cations in the water that is recirculating between the culture tank and plurality of subsystems, the concentration being at least about 0.1 ppm. The method may include measuring the actual concentration of iron cations in the water daily, at least once daily, from 2 to 4 times per week from 1 to 2 times per week, from 1 to 2 times per month, once per week, or once per month.

### BRIEF DESCRIPTION OF THE DRAWINGS

Advantages and features of the invention may be more completely understood by consideration of the following figures in connection with the detailed description provided below.

FIG. 1 is a schematic diagram of an exemplary RAS in accord with the present invention.

FIG. 2 is a schematic diagram of an embodiment of the RAS shown in FIG. 1.

### DETAILED DESCRIPTION OF THE INVENTION

Hydrogen sulfide is toxic to all aquatic species cultivated in aquaculture settings. Often called “the silent killer”, H₂S present in water-based habitats can lead to extensive losses of aquatic species accompanied by devastating economic losses and high damage potential within the market. The H₂S toxicity threshold varies for different aquatic species but is generally very low. For example, the H₂S toxicity threshold may be as low as 0.002 mg/L (2 μg/L) for various species of fish. As of today, an exact threshold for H₂S in RAS has not been established. A 96-hour LC₅₀ (lethal concentration 50) test is known and measures the concentration of H₂S dissolved in water which results in 50% mortality at the end of 96 hours of testing time. LC₅₀ values for freshwater species have been reported as low as 20-50 μg/L, whereas for marine species are 50-500 μg/L. It has been recommended that freshwater species be exposed to no more than 2 μg/L of H₂S, however, data pertaining to RAS are scarce. See Lein et al., “The SeaRAS AquaSense™ System: Real-Time Monitoring of H₂S at Sub μg/L Levels in Recirculating Aquaculture Systems (RAS)” Frontiers in Marine Science 9:1-8, 2022.

The mechanism of H₂S formation in closed freshwater RAS has been investigated, but in general, a complete picture has yet to be ascertained. H₂S formation may be linked to the natural sulfate (SO₄²⁻) concentration with estimates being about 5-50 mg/L in freshwater systems as described in Lein et al. The greater the sulfate concentration, the greater the chance of a mortality incident in RAS, as described by Letelier-Gordo et al., “Increased sulfate availability in saline water promotes hydrogen sulfide production in fish organic waste” Aquacultural Engineering 89: 1-8, 2020. H₂S formation may be linked to other factors including biodegradation processes governed by reduction-oxidation chemical reactions mainly under anoxic conditions in the presence of accumulated organic matter and bacteria. For example, sulfate reducing bacteria may produce H₂S from sulfate when dissolved levels of oxygen are low and which can occur if there is too little water flow through the accumulated organic matter. The organic matter can include fish feces, waste feed and biofilms, or other biosolid residuals, which tend to accumulate in pipes, sumps and biofilters. This accumulation can result in spikes in the concentration of H₂S if the organic matter breaks up and at least some portion is released into the water of the RAS. Yet another factor linked to H₂S formation is the presence of small molecular organic compounds, e.g., methane, which can react with sulfate to form HS⁻ and ultimately H₂S. There are orders of magnitude higher levels of sulfate in brackish water and seawater, where the opportunity for H₂S production is much higher than in freshwater.

Disclosed herein are a recirculating aquaculture system and method of maintaining the system and which are suitable for producing, cultivating, farming, rearing, harvesting, etc. aquatic species suitable for human consumption. The RAS and method enable the production of aquatic species in freshwater, brackish-water, and seawater while minimizing the risk of toxicity to the aquatic species, particularly toxicity related to the presence of H₂S. The RAS and method employ the use of chelating agents in the water being recirculated within the system. The chelating agents are selected to complex with iron cations, i.e., ferrous and ferric ions. As used herein, ferrous ion refers to the +3 oxidation state of iron also referred to as Fe(III), and ferric ion refers to the +2 oxidation state of iron also referred to as Fe(II). A minimum concentration of chelating agents is maintained in the water being circulated such that a minimum concentration of iron cations is always maintained in the water recirculating throughout the fish production system. Iron cations present throughout the recirculating water are available for chemical reaction with H₂S and various other components thought to contribute to the formation of H₂S. Chemical reaction between iron cations and H₂S is a redox reaction whereby H₂S is reduced to non-toxic elemental sulfur.

Addition of iron salts to the recirculating water of RAS does not provide a stable source of iron cations due to the presence of dissolved oxygen and the pH range of the water which is typically between about 6.0 to 9.0. These conditions can lead to oxidation of ferrous and ferric ions such that the ions are not available for chemical reaction with H₂S. Additionally, oxidation of ferrous and ferric ions can result in precipitation of iron oxides from the recirculating water. Iron oxide particles can harm fish gills and coat surfaces in the RAS.

The stability of iron cations in recirculating water can be increased by the addition of chelating agents. Any suitable chelating agent can be employed in the RAS and method described herein. The chelating agent may comprise a synthetic chelating agent, i.e., a non-naturally occurring chelating agent, or a chelating agent that is not readily biodegradable. Exemplary non-naturally occurring chelating agents include derivatives of acetic acid such as ethylenediaminetetraacetic acid (EDTA), hydroxyethylenediaminetetraacetic acid (HEDTA), nitrilotriacetic acid (NTA), diethylenetriaminepentaacetic acid (DTPA) and ethylenediamine-N,N′-bis(2-hydroxyphenylacetic acid (EDDHA). The chelating agent may comprise a naturally occurring chelating agent. Exemplary naturally occurring chelating agents include carboxylic acids such as citric acid, humic acid, fulvic acid, gluconic acid, lignosulfonic acid, glucoheptonic acid, any of the common amino acids, or combinations thereof.

The concentration of chelating agent maintained in the water circulating within the RAS can vary depending on the desired minimum concentration or range of concentrations of the iron cations. The concentrations of chelating agent and iron cations can depend, for example, on the particular aquatic species being produced, the carrying capacity of the RAS, the type of RAS employed (closed, semiclosed or open as described below), the amount and frequency of water replacement in the system, the feeding cycle, and the type of water (freshwater, brackish water and/or seawater). In addition, various parameters related to water quality are monitored and maintained in the RAS, and these parameters can at least partially determine the type and desired concentrations of chelating agents and iron cations in the water. Parameters related to water quality include, for example, temperature, dissolved oxygen, pH, hardness, ammonia, nitrates, carbon dioxide, chlorides, salinity, oxidation reduction potential, suspended solids, and so forth. The concentration of chelating agent can also depend upon the effectiveness of the chelating agent to complex with the iron cations. The equilibrium constant, defined relative to conditions of the water, can be a measure of the effectiveness of the chelating agent. The concentration of the chelating agent can be from about 0.1 to about 2 ppm, from about 0.1 to about 20 ppm, from about 2 to about 10, or from about 2 to 20 ppm, or greater than about 20 ppm.

The concentration of iron cations maintained in the water can be any useful concentration, for example, at least about 0.1 ppm, at least about 1 ppm, at least about 2 ppm or at least about 6 ppm. The concentration of iron cations in the water can be at least about 0.1 ppm, or at least about. 2 ppm. The concentration of iron cations may be within a range such as from about 0.1 ppm to about 100 ppm, from about 0.1 ppm to about 50 ppm, from about 0.1 ppm to about 20 ppm, or from about 2 ppm to about 10 ppm.

The concentration of iron cations in the water can be monitored according to any suitable schedule. For example, the concentration of iron cations can be measured daily, at least once daily, from 2 to 4 times per week from 1 to 2 times per week, from 1 to 2 times per month, once per week, or once per month.

The schedule may vary, for example, if water turnover rate in the RAS is sufficiently high to rapidly flush constituents (such as chelated iron) out of the system. Or, the schedule may vary if a non-synthetic chelate is used that is not stable and decays away more rapidly than some of the synthetic iron chelates. Also, the schedule may vary if filter, pipelines, or sumps are cleaned or if an H₂S spike is observed as a result of a break up of accumulated organic matter. Iron chelate can be proactively added to higher than normal levels when a cleaning event or disturbance of biofilms/sediments is planned. The concentration of iron cations is measured to give an actual concentration, and an appropriate amount of chelating agent may then be added to the water in response to the actual concentration.

Any suitable method may be used for measuring the concentration of iron cations in water samples collected from the RAS. A commonly used method employs 1,10-phenanthroline wherein an orange-red complex of iron cations forms with 1-10-phenanthroline, and the absorption spectrum is monitored using absorption spectroscopy in accordance with Beer's Law. Another method employs thiocyanate which forms a blood-red complex with iron cations.

The concentration of ferrous and ferric ions can be measured using a photometer equipped with an optical system and sufficiently narrow band interference for accuracy and precision. For example, Iron High Range Portable Photometer with CAL Check (Model HI97721), available from Hanna Instruments, Inc. may be used. This photometer is capable of measuring ferrous and ferric ions in water up to 5.00 mg/L. The HI97721 uses an adaptation of method 3500-Fe B, the phenanthroline method as described, for example, in Baird et al., Standard Methods for the Examination of Water and Wastewater. 23rd Edition. Washington, D.C.: American Public Health Association, 2017. In the phenanthroline method, iron is brought into solution and reduced to its ferrous state (Fe²⁺). The solution is then treated with 1,10-phenanthroline at a pH of 3.2 to 3.3. Three molecules of phenanthroline then react with one ferrous iron atom to form a complex with an orange color. The intensity of the color is directly proportional to the amount of ferrous iron in the sample.

Water being circulated in the RAS may be monitored for sulfate which can lead to formation of H₂S as described above. The concentration of sulfate maintained in the water circulating can depend, for example, on the particular aquatic species being produced, the carrying capacity of the RAS, the type of RAS employed (closed, semi-closed or open as described below), the amount and frequency of water replacement in the system, the feeding cycle, the types of chemicals added to the water (such as magnesium sulfate), and the type of water (freshwater, brackish water and/or seawater). The type of water can be of particular significance because the concentrations of sulfate in brackish water and seawater are much greater as compared to freshwater. As described above, various parameters related to water quality can at least partially determine the desired concentration of sulfate in the water.

The concentration of sulfate maintained in the water can be any useful concentration depending on whether the water is freshwater, brackish water, seawater, etc. The concentration of sulfate may be greater than about 10,000. For example, recirculating water in the RAS may include one or more of freshwater, brackish water, or seawater, and the concentration of sulfate maintained in the water may be greater than about 3000 ppm, or greater than about 500 ppm, from about 10,000 ppm to about 0.01 ppm, or from about 3000 ppm to about 0.01 ppm. For another example, recirculating water in the RAS may include freshwater and optionally brackish water, and the concentration of sulfate maintained in the water may be greater than about 3000 ppm, or greater than about 500 ppm, from about 10,000 ppm to about 0.01 ppm, or from about 3000 ppm to about 0.01 ppm. For yet another example, recirculating water in the RAS may include freshwater and optionally brackish water, and the concentration of sulfate maintained in the water may be less than about 500 ppm, less than about 200 ppm, or within a range of from about 1000 ppm to about 0.01 ppm.

According to APHA Standard Methods for Examination of Water and Wastewater, the following methods can be used to measure sulfate in water: gas chromatography, gravimetric methods, turbidimetric methods, and the automated methylthymol blue method. Details can be found in APHA Method 4500-SO42: Standard Methods for the Examination of Water and Wastewater; CFR Section: 40 CFR 136.3 (a). The concentration of sulfate in the water can be monitored according to any suitable schedule. For example, the concentration of sulfate can be measured daily, or 2 to 4 times per week.

The RAS and method disclosed herein can be used for producing any aquatic species suitable for aquaculture. Suitable aquatic species include diadromus fish such as salmon, trout and smelts; freshwater fish such as tilapia, bass, catfish, walleye, and perch; crustaceans such as shrimp, prawns, crayfish and crabs; molluscs such as oysters and claims; aquatic plants such as seaweed; and world aquaculture such as milkfish and mussels. The RAS and method disclosed herein are particularly employed for producing fish in the salmonid family, including for example, Atlantic and/or Pacific salmon, including Chinook or King salmon, Coho salmon, Sockeye salmon, Pink salmon, and Chum salmon, plus Atlantic salmon. Any of the aforementioned aquatic species can be produced singly as a monoculture, or a polyculture of more than one aquatic species can be produced.

The RAS and method disclosed herein can provide any type of suitable water-based habitat. Any type of water can be employed such as freshwater, brackish water, and salt or seawater. These categories of water are often defined by differences in concentration of dissolved salts referred to as salinity. Typically, freshwater has a salt concentration of less than about 1000 parts per million (ppm), brackish water between 1000 ppm and 30,000 ppm, and seawater between 30,000 ppm and 40,000 ppm. The RAS and method disclosed herein may utilize a single type of water, or a combination of freshwater, brackish water, and seawater. The water can be surface water that collects on the surface of a ground and which includes seawater or freshwater that is sent into wetlands, streams and lakes. The water can also be groundwater found in aquifers that are situated underground and which includes snowmelt and rainfall that gets into bedrock via the surrounding soil. Groundwater can contain salinities that range from near 0 to over 40,000 ppm depending on location and depth of the aquifer.

Recirculating aquaculture systems generally consist of an organized set of complementary processes or subsystems that can be designed and configured to allow at least a portion of water leaving a culture tank to be reconditioned and then reused in the same culture tank or one or more other culture tanks. An overview of RAS is provided in: Summerfelt. S. T., Julic Bebak-Williams, and Scott Tsukuda. “Controlled systems: water reuse and recirculation.” Fish hatchery management 40 (2001): 285-295 (hereinafter Summerfelt et al.).

The RAS and method disclosed herein can be used in a closed system in which the production of the aquatic species is relatively separate from the environment, and input and output of replacement water and various types of water treatments are controlled. Closed systems are those that recondition and recirculate water to the culture tank providing habitat to the aquatic species. These systems are not necessary “closed” in the sense that after the RAS is initially filled, some water flow enters the RAS to replace water that spills and evaporates, or that is flushed out of the RAS with wasted biosolids, or that is simply used to continuously flush through the RAS. Thus, closed systems can employ water replacement methods where some volume of cleaned and disinfected water is injected into the system and replaces water being recirculated. In some RAS architectures and methods, water being recirculated is replaced on a regular basis such as daily, multiple times per week, once per week or month, etc. depending on many factors such as the particular design of the RAS, the identity and amount of aquatic species being produced, the source of water being freshwater, brackish water or seawater. In some RAS architectures and methods, the amount of water being recirculated can vary depending on the aforementioned factors. For example, the RAS and method can be configured to replace recirculating water, by volume daily, less than about 500%, less than 400%, less than 200%, less than 100%, less than 10%, or less than 1%, or less than any other amount percent by volume as deemed necessary for providing and maintain a healthy, cost effective operation.

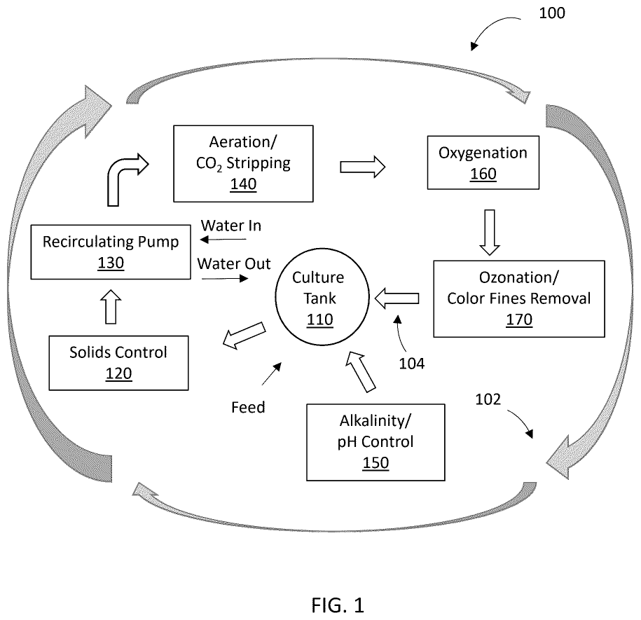

While many designs for RAS are known, fundamental and most commonly implemented steps are shown by way of example in FIG. 1. RAS 100 includes culture tank 110 that provides a water-based habitat to contain aquatic species during grow-out, enable feeding, and to flush feces. Culture tank 110 is designed, selected, implemented, etc. to provide for an environment that does not stress the aquatic species or cause physical damage to the species, minimizes undesirable transmission of pathogens and parasites, yet provides for high enough fish densities and other cost considerations for the RAS operation to be eco-friendly and profitable.

The RAS includes a plurality of subsystems which generally operate in series (but sometimes in parallel) and are in communication with culture tank 110. The subsystems are integrated with the culture take to circulate and treat water with the goal of maintaining a healthy, eco-friendly environment for the aquatic species while keeping costs for running the RAS profitable.

One such subsystem is oxygenation system 160 which provides or supplements the water with dissolved oxygen. Depending upon the species, for example, for warmwater or coldwater fish, optimum growth conditions require a minimum dissolved oxygen concentration of at least 60% to 90% of oxygen saturation at that temperature and atmospheric pressure. In RAS, the minimum dissolved oxygen concentration needs to be increased depending on a variety of factors, for example, the concentration of dissolved carbon dioxide, the carrying capacity of culture tank 110, pH, temperature, and/or the life stage of the species. In general, the dissolved oxygen concentration is desirably at close to or just above atmospheric saturation levels. The minimum dissolved oxygen concentration maintained in the culture tanks in a RAS may need to be from about 5 to about 20 mg/L, or from about 5 to about 12 mg/L.

Oxygenation 160 may be carried out using aerators and/or oxygenators. In general, oxygenation is carried out by contacting the water with purified oxygen at pressures greater than or equal to atmospheric pressure. Gas-to-liquid aerators may be used comprising a diffused aeration systems where gas (air or oxygen) is transferred to the water and exchange occurs, or aerators sometimes referred to as spargers/venturi injectors/aspirators which passes gasses through diffusers, perforated pipes or plates. Liquid-to-gas aerators may be used comprising, for example, a packed column aerator or a low-head oxygenator, or even a paddlewheel aerator. Liquid-to-gas aerators diffuse the water into small droplets to increase surface area available for contact with a continuous gas-phase, or they create an atmosphere enriched with gases for gas transfer.

Another subsystem employed as part of RAS 100 includes solids control system 120 which employs clarification and removal of solids via settling, sieving, flotation or contact filtration. As used herein, solids control system comprises removal of particulates having an average particle size greater than about 1 micron. Solids removal may be carried out generally using sedimentation units, granular filters or mechanical filters. For example, solids removal may be carried out using screen filters, settling basins, tube/plate settlers, roughing filters packed with random rock or plastic that is random or structured, swirl separators, pressurized filters such as those which employ sand, activated carbon or plastic beads, gravity filters which utilize high or slow rate sand, and or flotation/foam fractionation. Contact filtration occurs when typically fine particles (approximately 1-50 micron in size) come in contact with surfaces of the filter and stick to the surface until they can be removed as larger particles, which even occurs in the biofiltration media in RAS.

RAS 100 includes recirculating pump subsystem 130 to recirculate some volume of water within the system as well as to receive and supply replacement water as recirculated water is siphoned off. Recirculating pump subsystem 130 may comprise any suitable pump placed outside or within culture tank 110. Useful recirculating pumps include centrifugal pumps, axial flow pumps or airlift pumps. The particular choice of pump can depend upon many factors including the volume and rate of water being removed, the design of the RAS, and cost and reliability need also be considered.

RAS 100 includes aeration/CO₂ stripping subsystem 140 for removing dissolved carbon dioxide or other undesirable compounds such as H₂S and nitrogen-containing compounds present in the water being circulated. The concentration of such compounds can be decreased to levels close to above atmospheric saturation levels or any other desirable level depending on the design of the air-stripping system. In many RAS, the acceptable threshold for CO₂ is dependent upon the particular aquatic species being produced, the growth stage of the species, water quality such as pH, and the like. Carbon dioxide stripping can involve gas transfer whereby oxygen is infused in the water and results in replacement of CO₂ and N₂ with the dissolved gases approaching equilibrium. Carbon dioxide stripping subsystem 150 may comprise a stripping tower whereby water flow carrying dissolved CO₂ enters the tower and travels downward while air is blown through the tower (cross-flow, counter-flow, or concurrent flow). Surface aerators may also be employed, in which a propeller or paddles churn up the water and pumps it through an aerator. Diffuser aerators may also be employed. The particular choice of carbon dioxide stripping subsystem 150 may depend upon any number of factors such as volume, energy consumption, feed and water quality.

RAS 100 includes pH control subsystem 150 for maintaining the pH of the recirculating water. Typically, the pH of the recirculating water is maintained within a desired range. For example, the pH of the recirculating water may be maintained from about 5.0 to about 9.0. Other pH ranges may be employed as long as the RAS can function as desired. The pH control subsystem 150 can be configured to add alkaline chemicals in order to maintain the pH. Maintaining a pH or pH within a given range can be used to control the equilibrium of the ammonia nitrogen and carbonate carbon systems and the toxicity of metals such as Al. Other details regarding the need to maintain a pH or a pH within a given range are described in Summerfelt et al. Compounds for maintaining the pH or pH within a range include carbonates (such as CaCO₃), bicarbonates (such as NaHCO₃) and hydroxides (such as Ca(OH)₂).

RAS 100 includes ozonation/color fines removal subsystem 170 for supplying O₃ to the recirculating water. Ozone can be used to oxidize constituents in the recirculating water. For example, O₃ can be used to oxidize nitrite, organic matter, microbes, water color, odor, or off-flavor compounds. Sometimes an ozonation system can be used to breakdown tannen and humic substances, oxidize nitrite to nitrate, and microflocculate fine particulates that can be removed in the solids control subsystem or the biofilters described below. Ozone can also be used in the RAS as a disinfectant to improve water quality as described in Summerfelt et al.

FIG. 1 includes arrows 102, shown as circling around RAS 100, and which represent the flow of water to and/or from the above-described subsystems that surround culture tank 110. FIG. 1 includes arrows 104 which represent a general path between culture tank 110 and the subsystems. The location and direction shown for arrows 104 are not meant to be limiting, for example, pH control subsystem 150 may be integrated within RAS 100 such that it is between any two of the other subsystems.

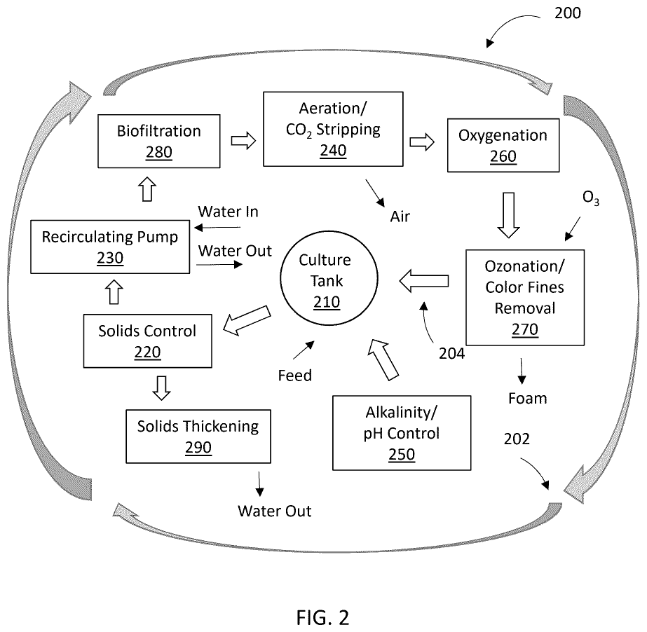

FIG. 2 is a schematic diagram of an embodiment of the RAS shown in FIG. 1. RAS 200 includes culture tank 210, solids control subsystem 220, recirculating pump subsystem 230, aeration/CO₂ stripping subsystem 240, pH control subsystem 250, oxygenation subsystem 260 and ozonation/color fines removal subsystem 270, any or all of which may be the same or similar to the respective subsystems described for FIG. 1 and/or as described in Summerfelt et al.

RAS 200 includes biofiltration subsystem 280 for elimination or control of harmful metabolic waste products with makeup depending on the specific aquaculture species being produced. Biofilters composed of microbial communities may be employed. Biofilters may be organized biofilm structures with compartments that include a fixed medium for microbrial attachment and growth, or suspension of microbial growth. Nitrification biofilters are employed to remove dissolved wastes from the RAS and maintain ammonia and nitrite concentrations below some acceptable threshold. Biofilters are used in RAS to decrease ammonia excreted by the fish, nitrite that is byproduct of the first step of nitrification, and organic matter and solid matter originate from uneaten feed and fish feces. The particular choice of biological filtration subsystem 160 may depend on any number of factors and research in this area continues to provide new solutions for use in RAS. RAS 200 includes solids thickening subsystem 290 as described in Summerfelt et al.

FIG. 2 also includes arrows 202 representing the flow of water as described for arrows 102, and arrows 204 representing a general, but non-limiting, path as described for arrows 204.

In some embodiments, RAS uses a single pump lift system, i.e., there is only one pump sump that lifts water to a top elevation as it passes through the biofilter and then allows the water to gravity flow back through the other processes on its way to the fish culture tanks and then through the solids removal units and finally back into the pump sump for another lift. If necessary, I could give a few other variations of the flow path, but these other variations are primarily to allow the system to have two flow loops or two lift station for double pumping the flow. Note that once water comingles in these two systems, the chelated iron would become mixed in both flow paths and would be expected to change very little unless a strong chemical reaction were to occur.

RAS 100 may include additional subsystems to disinfect or oxidize and precipitate or microflocculate or creating foam fractionation of fine biosolids in the system as well as to maintain water quality characteristics related to parameters such as oxidation reduction potential, pH, alkalinity, turbidity, and temperature as well as additional parameters described above.

RAS 100 can include subsystems for facilitating system operation at some semi-automated or nearly fully automated functioning. Examples of components which may be used in automation of the RAS include computers, computer networks, software and the like for data acquisition and control, etc., sensors for monitoring and control, alarms, automation and biosecurity as described in Summerfelt et al.

RAS 100 may be integrated with a hydroponic system for growing diverse crops for human use and/or consumption, including flowers, herbs, tomatoes, cucumbers, squash, melons, peas, carrots, leafy greens such as lettuce or spinach, certain halophytic plants, macro-algae, micro-algae, and the like. The hydroponic system can include a plant growing culture tank or tray subsystem, a grow light subsystem (or access to sunlight), a digester tank subsystem, and filtration and feed systems.

The concentration of iron cations can be obtained manually, for example, by retrieving one or more aliquots of the circulating water followed by measuring with a portable instrument such as the photometer described above. The concentration of iron cations can be obtained by automated instrumentation which may be distinctly integrated with the RAS or included with instrumentation used to monitor various parameters such as those pertaining to water quality.

The concentration of iron cations can be determined by measurements of samples obtained from one or more locations in the RAS. Samples may be taken at a location immediately before water enters or exits culture tank, or before or after water enters or exits any one or more of the subsystems. If measurements are taken at multiple locations, the samples may be obtained simultaneously or at different times.

Various modifications and additions can be made to the exemplary embodiments discussed herein without departing from the scope of the disclosed subject matter. For example, while the embodiments described refer to particular features, the scope of this disclosure includes embodiments having different combinations of the features and embodiments that do not include all of the described features. Accordingly, the scope of the disclosed subject matter is intended to embrace all such alternatives, modifications, and variations, together with all equivalents thereof. This application claims the invention described herein to the broadest extent possible as substantially disclosed herein.

What is claimed is:

1. A method of maintaining a recirculating aquaculture system for producing aquatic species suitable for human consumption, comprising:
maintaining a concentration of H₂S for water recirculating within a recirculating aquaculture system, wherein the concentration of H₂S is below a toxicity threshold for a selected aquatic species.

2. The method of claim 1 wherein maintaining the concentration of H₂S comprises maintaining a concentration of iron cations.

3. The method of claim 2 wherein the concentration of iron cations is less than about 100 ppm.

4. The method of claim 3 wherein the concentration of iron cations is from about 0.1 ppm to about 100 ppm.

5. The method of claim 3 wherein the concentration of iron cations is from about 0.1 ppm to about 20 ppm.

6. The method of claim 2 wherein the iron cations comprise ferrous and ferric ions.

7. The method of claim 2 wherein maintaining a concentration of iron cations comprises adding one or more chelating agents to the water recirculating within the recirculating aquaculture system, wherein the one or more chelating agents complex with the iron cations.

8. The method of claim 6 wherein the one or more chelating agents comprise a non-naturally occurring chelating agent selected from the group consisting of ethylenediaminetetraacetic acid, hydroxyethylenediaminetetraacetic acid, nitrilotriacetic acid, diethylenetriaminepentaacetic acid, ethylenediamine-N,N′-bis(2-hydroxyphenylacetic acid, and combinations thereof.

9. The method of claim 6 wherein the one or more chelating agents comprise a naturally occurring chelating agent selected from the group consisting of citric acid, humic acid, fulvic acid gluconic acid, lignosulfonic acid, glucoheptonic acid, an amino acid, and combinations thereof.

10. The method of claim 1 wherein the toxicity threshold is about 0.5 ppm or less.

11. The method of claim 1 wherein the toxicity threshold is about 0.5 ppm or less and the selected aquatic species is salmon.

12. The method of claim 1 wherein the selected aquatic species is salmon.

13. The method of claim 1 wherein the water recirculating within the recirculating aquaculture system comprises freshwater.

14. The method of claim 1 wherein the water recirculating within the recirculating aquaculture system comprises brackish water or seawater.

15. The method of claim 1 further comprising replacing less than about 500% by volume of the water recirculating within the recirculating aquaculture system on a daily basis with cleaned and disinfected groundwater or surface water.

16. The method of claim 15 wherein less than about 500% by volume comprises less than 10% by volume.

17. The method of claim 15 wherein less than about 500% by volume comprises less than 1% by volume.

18. The method of claim 7 further comprising measuring an actual concentration of the iron cations at least once daily, and optionally adding the one or more chelating agents in an amount needed to increase the actual concentration such that the concentration of H₂S is below the toxicity threshold for the selected aquatic species.

19. The method of claim 7 further comprising measuring an actual concentration of the iron cations two to four times per week, and optionally adding the one or more chelating agents in an amount needed to increase the actual concentration such that the concentration of H₂S is below the toxicity threshold for the selected aquatic species.

20. The method of claim 2 wherein maintaining a concentration of iron cations comprises measuring an actual concentration of the iron cations for an aliquot of the water recirculating within the recirculating aquaculture system, wherein measuring comprises adding a complexing agent to the aliquot to form a colored iron complex and obtaining an absorption spectrum of the colored iron complex.
